(19) United States
(12) Patent Application Publication
(10) Pub. No.: US 2011/0038771 A1
(43) Pub. Date: Feb. 17, 2011

(54) Particulate Air Filter With Ozone Catalyst and Methods of Manufacture and Use

(75) Inventors: Mark T. Buelow, Phillipsburg, NJ (US); Martin Volland, Jersey City, NJ (US)

Correspondence Address: BASF CATALYSTS LLC, 100 CAMPUS DRIVE, FLORHAM PARK, NJ, 07932, US

(73) Assignee: BASF Corporation, Florham Park, NJ (US)

(21) Appl. No.: 12/853,738

(22) Filed: Aug. 10, 2010

Related U.S. Application Data
(60) Provisional application No. 61/232,953, filed on Aug. 11, 2009.

(51) Int. Cl. B01D 53/86; B01J 8/08; B23P 11/00

(52) U.S. Cl. 423/210; 422/213; 29/428

(57) ABSTRACT

Methods and apparatus for destroying ozone in an air stream are provided. Specific embodiments comprise passing air through a particulate filter comprising a filter media folded into a plurality pleats and a plurality of separators, where the separators and/or the filter media is coated with an ozone destruction catalyst.

This application claims the benefit of priority under 35 USC §119(e) to U.S. Provisional Application Ser. No. 61/232,953, filed Aug. 11, 2009, which is incorporated herein by reference.

### TECHNICAL FIELD

The present invention relates generally to methods and apparatus for removing pollutants from a gas. More specifically, embodiments of the invention relate to a particulate air filter having an ozone destroying composition thereon for use in an air handling system.

### BACKGROUND

It is known to reduce the content of ozone from a gas through the employment of ozone removing compositions containing ozone removing materials. Such materials can include, for example, ozone catalyzing compositions, ozone adsorbing or absorbing materials and the like. It is also known to coat surfaces, such as metal surfaces, with ozone removing compositions to enable such surfaces to promote the removal of ozone from a gas such as by the conversion of ozone to harmless byproducts. The coating of such surfaces can be done by spraying, dipping, brushing and the like.

Heat exchange systems such as air conditioners are well known. Typical of such systems is an inlet for receiving a stream of gas (e.g., air) often generated by an internally mounted fan. The stream of air comes into contact with a series of coils containing a refrigerant so that the ambient air cools the refrigerant which is eventually used to reduce the temperature of a second stream of air that typically circulates within a structure such as a residence or business facility.

In recent years public and private agencies have committed to reducing ozone levels in the atmosphere. The reduction of ozone is accomplished by passing a stream of gas containing ozone (e.g., the atmosphere) into operative contact with a composition formulated at least in part for removing ozone from the stream of gas. Some ozone removing compositions especially those employing ozone catalysts require elevated temperatures to be effective. As a result, separate free standing, expensive ozone removing facilities are required.

There are a number of conventional porous substrates that have been used to carry the ozone depleting material and through which the atmosphere passes. While the prior art substrates function for their intended purpose, there are disadvantages or limitations associated with the prior art substrates.

A review of literature relating to pollution control reveals many references discussing the general approach of cleaning waste gas streams entering the environment. If too much of one pollutant or another is detected as being discharged, steps are taken to reduce the level of that pollutant, either by treating the gas stream or by modifying the process that produces the pollutant. However, there has been little effort to treat pollutants which are already in the environment; the environment has been left to its own self cleansing systems.

The difficulty with current ambient air cleaning devices used in the atmosphere is that they require new and additional equipment, and may be required to be operated separately just to accomplish such cleaning. Manganese oxides are known to catalyze the decomposition of ozone to form oxygen. Many commercially available types of manganese compound and compositions, including alpha manganese oxide are disclosed to catalyze the reaction of ozone to form oxygen. In particular, it is known to use the cryptomelane form of alpha manganese oxide to catalyze the reaction of ozone to form oxygen. U.S. Pat. Nos. 6,214,303, 6,375,902 and 6,375,905 discuss uses of cryptomelane and are incorporated by reference herein in their entirety.

Alpha manganese oxides are disclosed in references such as O'Young, Hydrothermal Synthesis of Manganese Oxides with Tunnel Structures, Modern Analytical Techniques for Analysis of Petroleum, presented at the Symposium on Advances in Zeolites and Pillared Clay Structures before the Division of Petroleum Chemistry, Inc. American Chemical Society New York City Meeting, Aug. 25-30, 1991 beginning at page 348. Such materials are also disclosed in U.S. Pat. No. 5,340,562 to O'Young, et al. Additionally, forms of α-MnO₂ are disclosed in McKenzie, The Synthesis of Birnessite, Cryptomelane, and Some Other Oxides and Hydroxides of Manganese, Mineralogical Magazine, December 1971, Vol. 38, pp. 493-502. For the purposes of the present invention, α-MnO₂ is defined to include hollandite (BaMn₈O₁₆.xH₂O), cryptomelane (KMn₈O₁₆.xH₂O), manjiroite (NaMn₈O₁₆.xH₂O), birnessite (Na_{0.3}Ca_{0.1}K_{0.1})(Mn⁴⁺, Mn³⁺)₂O₄.1.5H₂O and coronadite (PbMn₈O₁₆.xH₂O). O'Young discloses these materials to have a three dimensional framework tunnel structure (U.S. Pat. No. 5,340,562 and O'Young Hydrothermal Synthesis of Manganese Oxides with Tunnel Structures both hereby incorporated by reference).

There remains a need in the art for methods and apparatus for reducing pollutants without causing a drop in pressure, an impact on the filtration efficiency, significant expense or additional equipment.

### SUMMARY

One or more embodiments of the invention are directed to particulate filters comprising a filter media folded into a plurality pleats and a plurality of separators having two faces and two opposite side edges associated with the pleats. One or more of the separators and the filter media is coated with an ozone destruction catalyst.

Additional embodiments of the invention are directed to methods of making a particulate filter. A pleated filter media is formed by inserting a plurality of separators into the pleats and applying an ozone destruction catalyst to one or more of the separators and/or the filter media.

In some embodiments the separators have aluminum faces. In detailed embodiments, the separators are pleated in a direction perpendicular to the pleats of the filter media.

The ozone destruction catalyst of detailed embodiments comprises manganese oxide. In specific embodiments, the manganese oxide is α-MnO₂ selected from the group consisting of hollandite, cryptomelane, manjiroite, birnessite and coronadite. In more specific embodiments, the manganese oxide is cryptomelane. In further specific embodiments, the cryptomelane is substantially free of sulfate ions, chloride ions and nitrate ions. In additional specific embodiments, the cryptomelane is substantially free of copper or copper oxides.

In some embodiments, the filter media further comprises a flame retardant composition.

According to detailed embodiments, the ozone destruction catalyst is effective to remove ozone from air passing through the filter.

Further embodiments of the invention are directed to HVAC units comprising the particulate filter described herein in flow communication with air. Additional embodiments of the invention are directed to methods of treating air from the atmosphere comprising ambient air comprising passing the ambient air through the particulate filter described herein.

In detailed embodiments, the air flows through the particulate filter in a direction parallel to the separators. In detailed embodiments, the ozone destruction catalyst is effective to decrease ozone in the air.

### BRIEF DESCRIPTION OF THE DRAWINGS

FIG. 1 is a perspective view of a particulate filter according to one or more embodiment of the invention.

### DETAILED DESCRIPTION

Commonly assigned U.S. Pat. Nos. 5,422,331, 6,214,303, 6,375,902 and 6,375,905 are incorporated by reference herein in their entirety.

As used in this specification and the appended claims, the term “ozone destruction catalyst”, “ozone reducing catalyst”, “ozone depleting catalyst”, and the like, refers to any composition which is capable of reducing the amount of ozone which contacts the catalyst. Ozone destruction catalysts include compositions useful for catalyzing the conversion of pollutants present in the atmosphere to non-objectionable materials. Alternatively, ozone destruction catalysts include adsorption compositions which can be used to adsorb ozone and other pollutants, which can be destroyed upon adsorption, or stored for further treatment at a later time.

As used in this specification and the appended claims, the term “ambient air” refers to gas which is naturally or purposefully drawn or forced towards a pollutant treating substrate. It is also intended to include air which has been heated or cooled, either incidentally or by a heating means.

For the purposes of the present invention, α-MnO₂ is defined to include hollandite (BaMn₈O₁₆.xH₂O), cryptomelane (KMn₈O₁₆.xH₂O), manjiroite (NaMn₈O₁₆.xH₂O), birnessite (Na_{0.3}Ca_{0.1}K_{0.1})(Mn⁴⁺, Mn³⁺)₂O₄.1.5H₂O and coronadite (PbMn₈O₁₆.xH₂O)

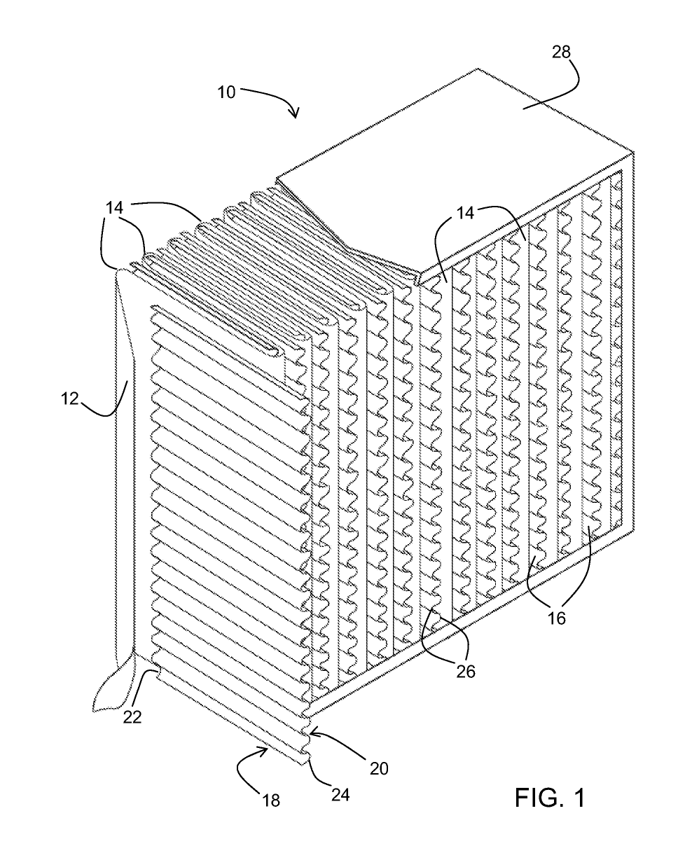

With reference to FIG. 1, one or more embodiments of the invention are related to particulate filters 10. The particulate filters 10 comprise a filter media 12 folded into a plurality of pleats 14 and a plurality of separators 16 having two faces, a front face 18 and a back face 20. The separators 16 also have two opposite side edges 22 and 24 associated with the pleats 14. One or more of the separators 16 and the filter media 12 is coated with an ozone destruction catalyst.

In specific embodiments, the separators 16 have aluminum faces. These separators 16 can be made of any suitable substrate with an aluminum coating, or can be comprises substantially only of aluminum.

In some detailed embodiments, as shown in FIG. 1, the separators 16 are pleated 26 in a direction perpendicular to the pleats 14 of the filter media 12.

The particulate filter 10 may optionally be enclosed within a frame 28. The frame 28 can be made of any suitable material, including but not limited to, paper-based products, metallic products and plastics. The choice of frame materials can alter the rigidity and strength of the particulate filter. Wider filters may benefit from stronger and/or stiffer frames.

Particulate filters according to various embodiments of the invention can be useful in residential, hospital and industrial environments. The size of the filter frame is dependent on the intended use and environment. The size of the filter media within the frame is variable based on the number of pleats, the thickness of the separators and the thickness of the filter media. For household uses, the filters have a frame with a typical width of about 1 inch. The length and width of household frames can be any size which meets the needs of household air handling systems. For hospital and industrial environments, the filter frames are often thicker. Specific examples of such filters include HEPA (high-efficiency particulate air) filters. Common frame sizes for HEPA filters are about 3 ft. by about 6 ft. by about 6 in. The frame sizes listed here are merely examples and are not to be taken as limiting the scope of the invention.

The ozone destruction catalyst of some detailed embodiments comprises manganese oxide. The manganese oxide of specific embodiments is substantially free of copper and copper oxides. This may be useful where aluminum is in contact with the ozone destruction catalyst. In some detailed embodiments, the manganese oxide is α-MnO₂ selected from the group consisting of hollandite, cryptomelane, manjiroite, birnessite and coronadite. In a very specific embodiment, the manganese oxide is cryptomelane. In even more specific embodiments, the cryptomelane is substantially free of sulfate ions, chloride ions and nitrate ions.

In some embodiments, the filter media 12 has a surface area in the range of about 100 and about 500 m²/g. In other embodiments, the filter media 12 has a surface area in the range of about 150 and about 450 m²/g, or in the range of about 200 and about 400 m²/g, or in the range of about 250 and about 350 m²/g. In specific embodiments, the filter media 12 has a surface area in the range of about 200 and about 250 m²/g. In other detailed embodiments, the filter media 12 has a surface area that is greater than about 50 m²/g, 100 m²/g, 150 m²/g, 200 m²/g, 250 m²/g, 300 m²/g, 350 m²/g, 400 m²/g or 450 m²/g.

In some embodiments, the filter media 12 also includes a flame retardant composition. When some ozone depleting compositions interact with the filter media there may be a chance of fire. A flame retardant composition applied to the filter media is effective to eliminate, or at least significantly reduce this possibility. Suitable flame retardant materials include, but are not limited to, gibbsite, functional-group modified nano-particles, silica based materials, polyester resins, melamine-formaldehyde resins, nanoclays, carbon nanotubes, layered hydroxides, polyhedral oligomeric silsesquioxane nanocomposites and carbon nanofibers.

Particulate filters and associated methods are useful in a variety of industries and applications. Examples of such industries and applications include, but are not limited to microelectronics, household, pharmaceutical, chemical and biological industries, nuclear air ventilation, waste incinerators, hospitals (operating rooms and emergency rooms), food industry, automotive industries, surface engineering, nanomaterials, space industries, military applications, power plants and movie theaters.

Embodiments of the invention may be of particular use in the aerospace industries. The weight of the air treatment systems are of significant concern in aerospace applications and combining the filters and ozone destruction capabilities into a single unit decreases the weight burden associated with such devices. Some detailed aerospace applications include, but are not limited to, cabin particulate filters on airplanes.

Additional embodiments of the invention are directed to methods of making a particulate filter. The methods comprise forming a pleated filter media by inserting a plurality of separators into the pleats and applying an ozone destruction catalyst to one or more of the separators and the filter media. The ozone destruction catalyst can be applied before or after the separators are inserted into the pleats. In fact, the catalyst can be added to either the filter media or the separators. When applied to the separators, the catalyst can be applied to either or both sides of the separators. In some detailed embodiments, the separators are also pleated in a direction perpendicular to the pleats of the filter media, as shown in FIG. 1.

Further embodiments of the invention are directed to HVAC units comprising the particulate filter previously described in flow communication with the air flow. In detailed embodiments, the air flows through the particulate filter in a direction parallel to the separators.

Still further embodiments of the invention are directed to methods of treating the atmosphere comprising ambient air. The methods comprise passing the air through the particulate filter previously described. In specific embodiments, the air passes through the particulate filter in a direction parallel to the separators. In so doing, the air spends a greater portion of time in contact with both the separators and the filter media.

Catalyst compositions can be used which can assist in the conversion of the pollutants to harmless compounds or to less harmful compounds. Useful catalyst compositions include compositions which catalyze the reaction of ozone to form oxygen. These catalyst compositions may also be capable of reacting with carbon monoxide to form carbon dioxide, and/or hydrocarbons to form water and carbon dioxide. In specific embodiments, the catalyst can catalyze the reactions of both ozone and carbon monoxide; or ozone, carbon monoxide and hydrocarbons.

### Ozone Catalysts

Useful catalyst compositions to treat ozone include a composition comprising manganese compounds including oxides such as Mn₂O₃ and MnO₂ with a specific composition comprising an α-MnO₂ being and cryptomelane. Other useful compositions include, but are not limited to, a mixture of MnO₂ and CuO, hopcalite (which contains CuO and MnO₂), Carulite™ (which contains MnO₂, CuO and Al₂O₃ and sold by the Cams Chemical Co.).

In some specific embodiments, the composition comprises a refractory metal oxide support on which is dispersed a catalytically effective amount of a palladium component and, in even more specific embodiments, also includes a manganese component.

Additional specific embodiments have a catalyst comprising a precious metal component on a support of coprecipitated zirconia and manganese oxide. The use of this coprecipitated support has been found to be particularly effective to enable a platinum component to be used to treat ozone. Yet another specific embodiment comprises carbon, and palladium or platinum supported on carbon, manganese dioxide, Carulite™ and/or hopcalite. Another specific embodiment uses manganese supported on a refractory oxide such as alumina.

### Ozone and Carbon Monoxide Catalysts

Useful catalysts which can treat both ozone and carbon monoxide comprise a support such as a refractory metal oxide support on which is dispersed a precious metal component. The refractory oxide support can comprise a support component selected from the group consisting of ceria, alumina, silica, titania, zirconia, and mixtures thereof.

Also useful as a support for precious metal catalyst components is a coprecipitate of zirconia and manganese oxides. In detailed embodiments, this support is used with a platinum component and the catalyst is in reduced form. This single catalyst has been found to effectively treat both ozone and carbon monoxide. Other useful precious metal components are comprised of precious metal components selected from palladium and also platinum components with palladium preferred. A combination of a ceria support with a palladium component results in an effective catalyst for treating both ozone and carbon monoxide.

Other useful catalysts to treat both ozone and carbon monoxide include a platinum group component (a platinum component, palladium component, or a platinum component on titania or on a combination of zirconia and silica). Other useful compositions which can convert ozone to oxygen and carbon monoxide to carbon dioxide include a platinum component supported on carbon or on a support comprising manganese dioxide. In detailed embodiments, the catalysts are reduced.

### Ozone, Carbon Monoxide and Hydrocarbons Catalysts

Useful catalysts which can treat ozone, carbon monoxide and hydrocarbons, typically low molecular weight olefins (C₂ to about C₂₀) and typically C₂ to C₈ mono-olefins and partially oxygenated hydrocarbons as recited comprises a support on which is dispersed a precious metal component. In specific embodiments the support is a refractory metal oxide which can comprise a support component selected from the group consisting of ceria, alumina, titania, zirconia and mixtures thereof. In more specific embodiments, the refractory metal oxide support is titania.

Useful precious metal components are comprised of precious metal components selected from platinum group components including palladium and platinum components. In detailed embodiments, the precious metal component is platinum. It has been found that a combination of a titania support with a platinum component results in an effective catalyst for treating ozone, carbon monoxide and low molecular weight gaseous olefin compounds. In detailed embodiments, the platinum group components are reduced with a suitable reducing agent.

Other useful compositions which can convert ozone to oxygen, carbon monoxide to carbon dioxide, and hydrocarbons to carbon dioxide include a platinum component supported on carbon, a support comprising manganese dioxide, or a support comprising a coprecipitate of manganese oxides and zirconia. Catalysts of specific embodiments are reduced.

The above compositions can be applied by coating to at least one atmosphere contacting surface. Particularly useful compositions catalyze the destruction of ozone, carbon monoxide and/or unsaturated low molecular weight olefinic compounds at ambient conditions or ambient operating conditions. Ambient conditions are the conditions of the atmosphere. By ambient operating conditions it is meant the conditions, such as temperature, of the air contacting surface during normal operation without the use of additional energy directed to heating the ozone reducing composition. In detailed embodiments, the catalyst is effective over a temperature range of about 5° to about 30° C.

The various catalyst compositions described can be combined, and a combined coating applied to the filter media and/or separators. Additionally, different catalyst compositions can be applied to the filter media and the separators.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A particulate filter comprising a filter media folded into a plurality pleats and a plurality of separators having two faces and two opposite side edges associated with the pleats, one or more of the separators and the filter media is coated with an ozone destruction catalyst.

2. The particulate filter of claim 1, wherein the separators have aluminum faces.

3. The particulate filter of claim 1, wherein the separators are pleated in a direction perpendicular to the pleats of the filter media.

4. The particulate filter of claim 1, wherein the ozone destruction catalyst comprises manganese oxide.

5. The particulate filter of claim 4, wherein the manganese oxide is α-MnO₂ selected from the group consisting of hollandite, cryptomelane, manjiroite, birnessite and coronadite.

6. The particulate filter of claim 4, wherein the manganese oxide is cryptomelane.

7. The particulate filter of claim 6, wherein the cryptomelane is substantially free of sulfate ions, chloride ions and nitrate ions.

8. The particulate filter of claim 1, wherein the filter media further comprises a flame retardant composition.

9. A method of making a particulate filter comprising forming a pleated filter media by inserting a plurality of separators into the pleats and applying an ozone destruction catalyst to one or more of the separators and/or the filter media.

10. The method of claim 9, wherein the ozone destruction catalyst comprises manganese oxide.

11. The method of claim 10, wherein the manganese oxide is α-MnO₂ selected from the group consisting of hollandite, cryptomelane, manjiroite, birnessite and coronadite.

12. The method of claim 10, wherein the manganese oxide is cryptomelane.

13. The method of claim 12, wherein the cryptomelane is substantially free of sulfate ions, chloride ions and nitrate ions

14. The method of claim 9, wherein the separators have an aluminum face.

15. The method of claim 9, wherein the separators are pleated in the direction perpendicular to the pleats of the filter media.

16. The method of claim 9, further comprising applying a flame retardant composition to the filter media.

17. A HVAC unit comprising the particulate filter of claim 1 in flow communication with air, wherein the air flows through the particulate filter in a direction parallel to the separators.

18. A method of treating air from the atmosphere comprising ambient air comprising passing the ambient air through the particulate filter of claim 1.

19. The method of claim 18, wherein the air passes through the particulate filter in a direction parallel to the separators.

20. The method of claim 18, wherein the ozone destruction catalyst comprises manganese oxide comprising α-MnO₂ selected from the group consisting of hollandite, cryptomelane, manjiroite, birnessite and coronadite.
